(19) United States
(12) Patent Application Publication
(10) Pub. No.: US 2014/0012637 A1
(43) Pub. Date: Jan. 9, 2014

(54) TRAFFIC DELAY DETECTION BY MINING TICKET VALIDATION TRANSACTIONS

(71) Applicants: Boris Chidlovskii, Meylan (FR); Eduardo Cárdenas Sánchez, San Nicolas de los Garza, N.L. (MX)

(72) Inventors: Boris Chidlovskii, Meylan (FR); Eduardo Cárdenas Sánchez, San Nicolas de los Garza, N.L. (MX)

(73) Assignee: Xerox Corporation, Norwalk, CT (US)

(21) Appl. No.: 13/553,614

(22) Filed: Jul. 19, 2012

Related U.S. Application Data
(60) Provisional application No. 61/668,524, filed on Jul. 6, 2012.

(51) Int. Cl. G06Q 50/30

(52) U.S. Cl. 705/13

(57) ABSTRACT

A method, system and processor-readable medium for detecting traffic delays A transfer time sample can be analyzed from ticketing data (e.g., ticket validation timestamps) that includes data indicative of a plurality of stops. An optimal set of stop pairs can be selected from among the plurality of stops based on a plurality of factors including a coverage, a volume and a distance between at least two stops among the plurality of stops. A structural outlier associated with the transfer time sample can be then detected in order to detect traffic delays determined from the optimal set of stop pairs selected from among the plurality of stops. Note that such a structural outlier can comprise an outlier in a spatio-temporal series collected from the transfer time sample.

### CROSS-REFERENCE TO PROVISIONAL APPLICATION

This patent application claims the benefit under 35 U.S.C. §119(e) of U.S. Provisional Application Ser. No. 61/668,524, which was filed on Jul. 6, 2012 and is incorporated herein by reference in its entirety.

### TECHNICAL FIELD

Embodiments are generally related to ATV (Automatic Ticketing Validation) methods and systems. Embodiments are also related to AVL (Automatic Vehicle Location) methods and systems. Embodiments are additionally related to the detection and monitoring of traffic delays.

### BACKGROUND OF THE INVENTION

Many urban and agglomeration public transportation networks have deployed ATV (Automatic Ticketing Validation) systems for fare collection. A typical ATV system includes ticket validation machines installed on board of the public transportation vehicles. They represent the Automatic Fare Collection (AFC) subsystems designed to reduce the human presence and to eliminate the fare evasion. Each validation records the ticket ID, the location and timestamp. Alternatively, the ATV system can use the Automatic Vehicle Location (AVL) subsystems to associate the validation with the bus line, stop identifier and direction.

The ensemble of ticket validations collected in an ATV system represents a valuable information for understanding the vehicle and passenger flows in the network. Data collected by ATV systems can be analyzed in order to provide valuable insights for the transit and public transportation agencies and assist them in the decision making processes.

Public transportation vehicles (e.g., buses, metro, etc) are subject to diversion and delays due to a road traffic collision. If a bus is delayed, the driver notifies the Transportation Services Department via a communications radio in the bus. If the bus is equipped with an AVL system, it detects any delay beyond the schedule and informs the agency.

Automatic vehicle location (AVL) is an automated vehicle tracking system made possible by navigational technologies such as Global Positioning Systems (GPS). AVL is used for monitoring the emergency location of vehicles and fleet management. AVL systems use dead reckoning and signposts whereby signals were transmitted from a mobile unit to stationary signposts and the position of the vehicle was determined based on known information about the signpost locations.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a method, system and processor-readable medium for detecting traffic delays.

It is another aspect of the disclosed embodiments to provide for analyzing transfer time samples from ticketing data for use in detecting traffic delays.

It is yet another aspect of the disclosed embodiments to provide for the use of one or more structural outliers collected from a transfer time sample for use in detecting traffic delays.

The aforementioned aspects and other objectives and advantages can now be achieved as described herein. A method, system and processor-readable medium for detecting traffic delays is disclosed. In general, a transfer time sample can be analyzed from ticketing data that includes data indicative of a plurality of stops. An optimal set of stop pairs can be selected from among the plurality of stops based on a plurality of factors including a coverage, a volume and a distance between at least two stops among the plurality of stops. A structural outlier associated with the transfer time sample can be then detected in order to detect traffic delays determined from the optimal set of stop pairs selected from among the plurality of stops. Note that such a structural outlier can comprise an outlier in a spatio-temporal series collected from the transfer time sample. Additionally, the ticketing data can include ticket validation timestamps.

Ticket validation timestamps can thus be employed as an alternative source for traffic problem detection. The disclosed approach infers the transfer time between stops from validation timestamps and determines the simultaneous appearance of outliers in samples for different stops.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a license plate optical character recognition module, an operating system, and a user interface, in accordance with the disclosed embodiments;

FIG. 3 illustrates a group of graphs and charts to demonstrate tracking of transfer time between different stops, in accordance with the disclosed embodiments.

FIG. 4 illustrates stop-to-stop transfer time samples for a bus line, in accordance with the disclosed embodiments;

FIG. 5 illustrates graphs respectively depicting example data indicative of bus stop values for one route and route coverage by a selected pair of stops, in accordance with the disclosed embodiments; and

FIG. 6 illustrates a high-level flow chart of operations depicting logical operational steps of a method for detecting traffic delays, in accordance with an embodiment.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein describe an improved method, system and processor-readable medium for detecting delays in transportation systems, such as, for example, public transport vehicle ridership. Instead of (or together with) an AVL system, ticket validation data can be mined for traffic detection cases.

Two main points are stressed here. First, ticket validation data is a massive dataset which can be used to track traveler activities. Ticket validation data represents an important source of information for PT traffic analysis and monitoring. Since all buses are equipped with fare collection systems, for example, they generate a massive collection of fare transactions with timestamps, which can be analyzed for critical insights on bus ridership. Second, the disclosed embodiments can be complementary to AVL systems. In PT installations where AVL is not available or where existing AVL offers a partial coverage (not all buses/routes are equipped with AVL), the analysis of ticket validations can compensate the miss. As will be described in greater detail herein, under certain conditions, this analysis can produce statistically reliable insights about the traffic.

As will be discussed in further detail herein, traffic detection is presented as the structural outlier detection in spatio-temporal series produced by ticket validation timestamps. Using a simple example, a transfer time between bus stops can be identified as the core element for capturing both normal and abnormal episodes in bus rides. As will also be discussed in greater detail, some critical issues can be identified when configuring a robust and accurate detector. The stop selection can be formalized as an combinatorial optimization problem and a greedy algorithm can be utilized to solve such a problem in an approximate manner. Additionally, implementation details and simple report evaluation for a Nancy dataset are described herein.

Before further discussion of embodiment details, it will be appreciated that the present invention can be implemented in a variety of different embodiments and contexts, such as for example, a method, data-processing system, or computer program product/processor-readable medium. Accordingly, the present invention may in some embodiments take the form of an entirely hardware embodiment, or in other embodiments, as an entirely software embodiment. Other embodiments can combine software and hardware aspects all generally referred to herein as a “circuit” or “module.” The present invention may take the form of a computer program product on a computer-usable storage medium having computer-usable program code embodied in the medium. Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.) The computer program code, however, for carrying out operations of the present invention may also be written in conventional procedural programming languages, such as the “C” programming language or in a visually oriented programming environment, such as, for example, visual basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, WiMax, 802.11x, and cellular network or the connection can be made to an external computer via most third party supported networks (e.g. through the Internet via an internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified herein.

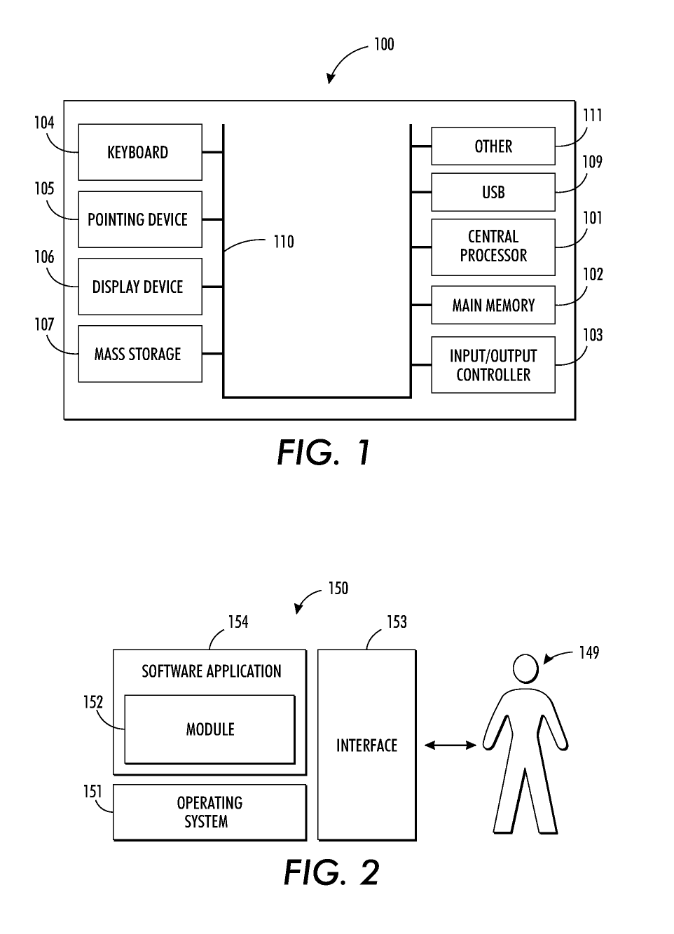

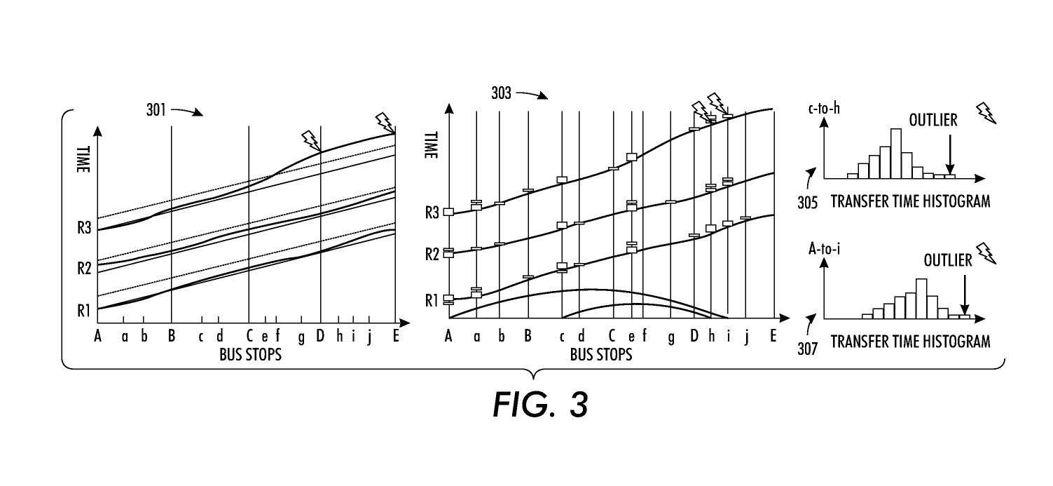

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, pen device, etc), a display device 106, a mass storage 107 (e.g., a hard disk), a USB (Universal Serial Bus) peripheral connection 109 and “other” components 111. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes or is associated with a kernel or operating system 151 and a shell or interface 153. The software application 154 can include a module 152 (e.g., software module). One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application. Thus, for example, module 152 shown in FIG. 2 may be implemented as such a module and may include instructions for implementing the method(s) and/or approach described herein.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The interface 153, which is preferably a graphical user interface (GUI), can serve to display results, whereupon a user may supply additional inputs or terminate a particular session. In some embodiments, operating system 151 and interface 153 can be implemented in the context of a “windows” system. It can be appreciated, of course, that other types of systems are potential. For example, rather than a traditional “windows” system, other operation systems, such as, for example, a real time operating system (RTOS) more commonly employed in wireless systems may also be employed with respect to operating system 151 and interface 153.

FIGS. 1-2 are thus intended as examples, and not as architectural limitations of the disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, Unix, Linux, and the like.

Turning now to transportation systems, it can be appreciated that any delay in, for example, a bus ride can cause delays in passenger boarding's and therefore delays in their ticket validations. The disclosed embodiments address the inverse problem. The ticket validation timestamps can be analyzed in order to automatically determine important bus delays due to incidents, congestions or other problems. The core element derives from observing the transfer time between two bus stops on a given route. Bus ridership is a complex spatial-temporal process and the transfer time between two stops is an object of unknown and unobserved factors. While a few validation timestamps may give an unclear and random picture, a large number of validations can be collected in order to analyze them and to build a robust detector.

A number of factors can be considered with respect to the disclosed embodiments. First, important traffic problem results in a critical deviation from the expected transfer time, and such deviation can be statistically measured. The deviation often concerns not one or two, but multiple stops at the same time. The traffic cases can be treated as the outlier detection in the transfer time for stops affected by the delay.

In general, the traffic problem can be expressed as the structural outlier detection in spatio-temporal series produced by ticket validation timestamps. A transfer time between two bus stops can be identified as the core criteria for capturing both normal and abnormal episodes in bus rides. Additionally, above can be extended by identifying core aspects to take into account in order to configure a robust and accurate predictor. These aspects can include, for example, the traffic volume between the stops and its regularity, the distance between stops and the coverage of the route by selected segments. Additionally the task can be defined as a selection of bus stop pairs and expressed as a combinatorial optimization problem. Due to the NP-completeness of the task, a greedy solution to the stated problem can be provided, which is proved to be close to the optimal solution.

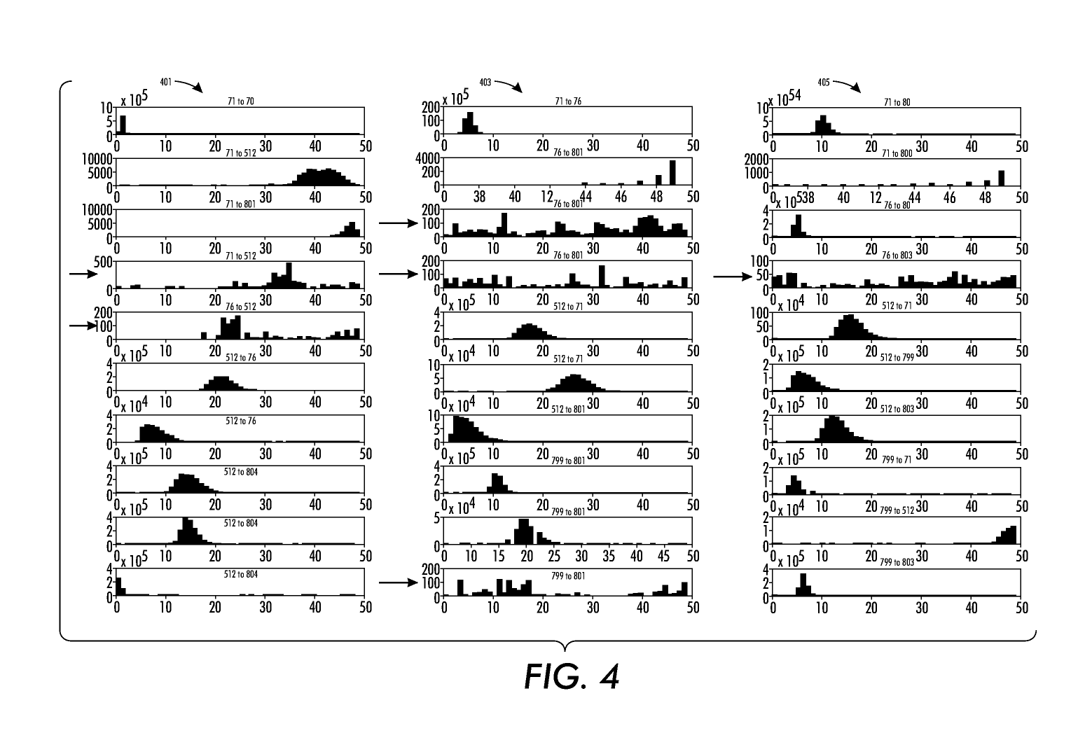

FIG. 3 illustrates a group of graphs and charts to demonstrate tracking of transfer time between different stops, in accordance with the disclosed embodiments. The simple examples shown in FIG. 3 includes graphs 301, 303 and histograms 305, 307. Graph 301, for example, illustrates a time-space chart for a bus line with 15 stops. It can be assumed that five of these stops (A, B, C, D, E) are equipped with AVL signposts (shown as vertical lines in graph 301). Graph 301 further indicates three bus rides R1, R2 and R3, and straight lines that trace their schedule time, with additional lines indicating the maximal ride delay (for example, set to 10 minutes beyond the schedule). The real rides are also indicated. When the ride track crosses a line, a delay message is triggered. As the graph indicates, R1 and R2 rides went OK, while ride R3 triggered a delay warning at stops D and E. Graph 301 thus indicates a) Ride delay in AVL system, and graph 303 indicates ride delay by mining validation timestamps. Histograms 305 and 307 indicates delays as outliers in transfer time. Graph 303 follows the same example, where the fare collection system is utilized instead of AVL. In this case, the schedule is not available, and ticket validation timestamps are recorded at all stops. In graph 303, validation timestamps are shown strips for all stops and rides.

The disclosed embodiments track the transfer time between different stops, provided by passengers validating their tickets during the same ride. Histograms 305, 307 are transfer time histograms for two selected stop pairs, from ‘c’ to ‘h’ and from ‘A’ to ‘i’ (shown as segments in the diagram). To determine the delay in ride R3, two conditions should be satisfied. First, the delay should be observed as a deviation from the expected behavior. Second, such deviations should occur simultaneously in multiple stop pairs covering different segments of the route, including ‘c-to-h’, ‘A-to-i’ and others. Arrows in the distribution plots indicate delays as outliers in the transfer time.

The traffic detection problem can be defined as tracking abnormal behavior in the transfer time between bus stops along the bus route. The structured outlier detection can constitute the method where transfer time outliers are simultaneously caught for different stop pairs. For multi-stop lines, a number of stop pairs can be selected for the simultaneously outlier tracking. When selecting the pairs, the following issues can be take into account:

Validation volume: Stops with dense validation volume are preferred to stops with low one, as they are likely to contribute in statistically reliable predictions;

Distance: Tracking the transfer time between two remote or two neighbor stops can catch events of different granularity, on global and local level. It is preferable that both cases are represented in the selection.

Coverage: Sampling the transfer time between bus stops reflect both normal and abnormal events occurred within the corresponding line segment. Therefore, the selection of stop pairs should cover the whole line. No stop should remain without covering by at least one time tracking.

Quality control: When ADC generates erroneous timestamps making the transfer time between some stops out of utility. Therefore, those bus pairs which are allowed to contribute to the traffic detection problem should be assessed.

As will be explained in greater detail, there are three main contributions to the method, namely, the quality control of transfer time samples, the selection of stop pairs, and the structural outlier detection on the selection.

The transfer time sample between stops is a collection of values t=t″−t′ where t″ and t′ are validation timestamps at si and sj during the same ride, registered by different passengers. Given the transfer time sample, the quality control refers to checking if the sample induced by validation timestamps is consistent with structural outlier detection. We use the normality test to reject cases when data cannot be assessed and therefore deployed for the outlier detection. Specifically, the Lilliefors test of the default null hypothesis that the transfer time sample comes from a distribution in the normal family can be employed, against the alternative that it does not come from a normal distribution. In general, the Lilliefors test is a 2-sided goodness-of-fit test suitable when a fully-specified null distribution is unknown and its parameters must be estimated. The Lilliefors test statistic is the same as for the Kolmogorov-Smirnov test as indicated by Equation (1) below:

K S=maxₓ|SCDF(x)−CDF(x)|, (1)

As indicated in Equation (1), SCDF represents the empirical cdf estimated from the sample and CDF is the normal cdf with mean and standard deviation equal to the mean and standard deviation of the sample. The test returns the logical value h=1 if it rejects the null hypothesis at the given significance level (β=5%), and h=0 otherwise.

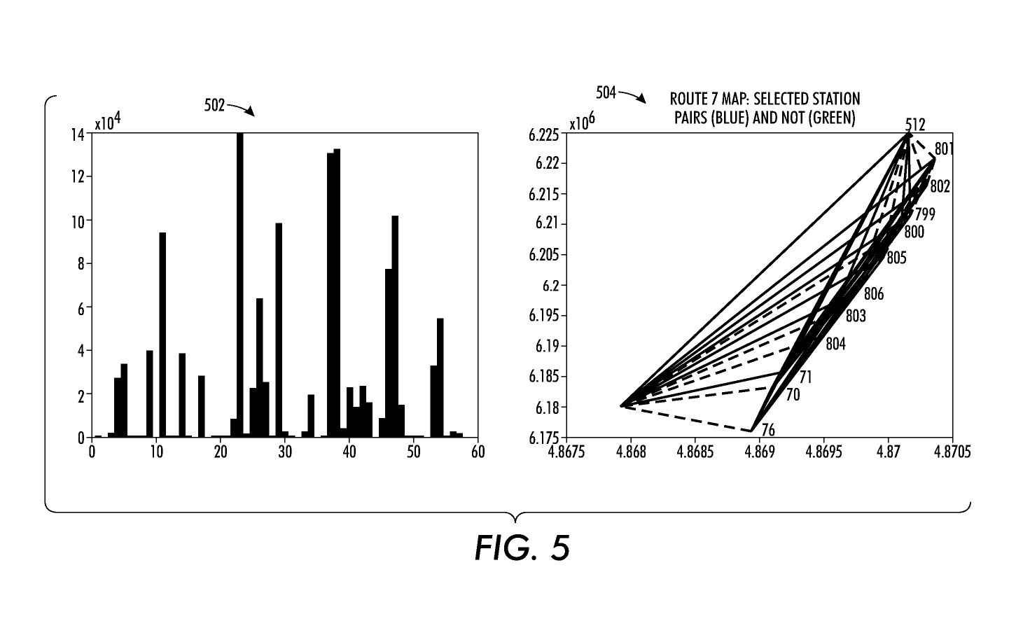

FIG. 4 illustrates stop-to-stop transfer time samples for a bus line, in accordance with the disclosed embodiments. Such time samples are indicated by graphs 401, 403, and 405. As shown in FIG. 4, one bus line is processed in Nancy and transfer time distributions processed for 30 randomly selected stop pairs. Most of the pairs successfully pass the normality test. Instead, pairs in positions 8, 10, 11, 12, 13 and 29 (pointed by arrows) fail to pass the test and therefore unlikely to be selected.

Once stop pairs are assessed, the problem of selecting an optimal set of stop pairs for the structural outlier detection can be addressed. Naive solutions, like all close stops (si, si+1), i=1, . . . , n-1 or the longest one (s1, sn), are unsatisfactory, as they take into account coverage but ignore the volume and distance issues, explained above.

The selection of the stop pairs for structural outlier detection as an optimization problem is presented. Assume we dispose n stops along a selected route, s1 , . . . sn. A binary variable xij can be associated with the pair of stations (si,sj) where xij is 1 if (si,sj) is selected, 0 otherwise. The problem is to determine N stop pairs which maximize a cost function and satisfy a number of linear coverage constraints as represented by equation (2) below:

maximize Σᵢ₌₁ⁿ Σ_{j>i}ⁿ wᵢⱼxᵢⱼ

subject to Σᵢ₌₁ⁿ Σ_{j>i}ⁿ xᵢⱼ≦N,

lₖ≦Σᵢ₌₁ⁿ Σ_{j>i}ⁿ cₖ(xᵢⱼ), k=1, . . . , n,

xᵢⱼ ∈ {0, 1} (2)

For Equation (2) above, the value or variable N represents the number of selected pairs, N<n(n-1)/2. Additionally, wᵢⱼ represents the weight of the binary variable xᵢⱼ. Additionally, cₖ represents the coverage index for stop sₖ,cₖ(xᵢⱼ)=1 iff xᵢⱼ=1 and i≦k≦j, 0 otherwise. Also, lₖ represents the minimum allowed coverage for stop sₖ,0≦lₖ≦N; in practice we often have lₖ=1 for all k.

Weights wᵢⱼ are set to aggregate two factors, the quality control and the validation volume for pair (sᵢ,sⱼ). The quality is measured by the normality test for the transfer time distribution, hᵢⱼ; the validation volume is denoted vᵢⱼ.

The weights play a double role. On one side, they should penalize cases when the transfer time sample is different from the normal distribution. Second, they should favor pairs with a large volume of validation timestamps for fixed period of time. To fit these goals, we set the weight for (sᵢ,sⱼ) as the product of two factors, wᵢⱼ=hᵢⱼvᵢⱼ.

Thus, problem (2) becomes a combinatorial optimization problem, it is a generalization of 0-1-knapsack problem. Even a simpler version of the problem where ck are constants and independent of xij is NP-hard.

The exact solution to the problem should be approximated. Instead of approximating the solution for (2), we reshape it as a weighted set covering problem for which there exist efficient approximations.

We denote P the set of n stops, P={1,2, . . . , n}. Each stop pair which passed the quality test, defines a subset of stops it covers. There are m≦n(n-1)/2 such subsets, F={P1, . . . , Pm}, Pj ⊂ P, such that ^{□j} Pj=P and each Pj has a positive real weight cj. Any 0-1 valued multiple y=(y1, . . . , ym) constitutes a cover for P in which the number of times that stop i is covered is defined to be the sum of yj's for those Pj's which contain i and the total weight of the multiple cover is defined to be ^{␣j} cj yj. The weighted set covering problem seeks a sub-collection C ⊂ F yielding the minimum weight multiple cover for P, such that every element i is covered at least 1 time. By defining ail to be 1 when i ∈ Pj and 0 otherwise, we can rewrite the above problem as follows:

minimize Σⱼ₌₁ cⱼyⱼ

subject to 1≦Σⱼ₌₁^{m} aᵢⱼyⱼ, i=1, . . . , n,

yⱼ ∈ {0, 1}, (3)

The exact solution to Equation (3) being NP-complete, it can be approximated to a factor of H_{d}=log d+O(1), where d=max {|S|: S ∈ F}. As indicated below, a greedy algorithm can be employed for the pair selection, which can be derived from the greedy heuristics for the weighted set coverage. At each step, such an algorithm can calculate the weighted cost for each of the remaining candidates and greedily selects the best. Because Equation (3) is a minimization problem, and subset Pj ∈ F has volume cj, its cost can be set to cⱼ=1/vⱼ.

Algorithm 1 Weighted route covering algorithm.

| Input: Set F = {P₁, . . . , Pₘ} of m stop pairs/stop subsets with validation | |
|---|---|
| volumes v₁, . . . , vₘ | |
| Output: A subset C ⊂ F of stop pairs covering the stop set P | |
| 1: | for every subset Pⱼ do |
| 2: | Set up weight cⱼ = 1/vⱼ |
| 3: | end for |
| 4: | C := |
| 5: | P := {1, . . . , n} |
| 6: | while P ≠ do |
| 7: | $Find set {P}_{j} ∈ F \text{∖} C that minimizes α := \frac{{c}_{j}}{\vert {P}_{j} ⋂ P \vert} .$ |
| 8: | C := C ∪ {S} |
| 9: | P := P\S |
| 10: | end while |
| 11: | return C |

If the algorithm returns |C| pairs and N>|C| pairs are needed, the algorithm can be completed by sorting the remaining candidates and selecting-N|C| pairs with the minimal costs cᵢ. Also, the algorithm can be extended to the minimal stop coverage different from 1.

Once a set of N stop pairs is selected by Algorithm 1, we apply the structured outlier detection to determine the traffic problem. The transfer time for N transfer time samples form multivariate data; its shape and size can be quantified by a covariance matrix. We use the Mahalanobis distance as the measure, which takes into account the covariance matrix. For a N-dimensional multivariate sample ti, i=1, . . . , p, the Mahalanobis distance can be defined as follows by Equation (4):

M Dᵢ=((tᵢ−μ)^{T} C⁻¹(tᵢ−μ)^{1/2} for i=1, . . . , p, (4)

In Equation (4) above, the variable μ represents the estimated multivariate mean location and C is the estimated covariance matrix. Multivariate outliers can be simply defined as observations having a large squared Mahalanobis distance. For the structured outlier detection, we generate a N-dimensional multivariate observations from N bus pairs collected during the same period of time. Large Mahalanobis distance values will indicate the most likely traffic delay cases.

All method elements described in the previous sections, including the transfer time analysis and normality test, the stop pair selection and structural outlier detection have been implemented for a Nancy city case, and the ticket validation dataset available for the period from July to November 2010.

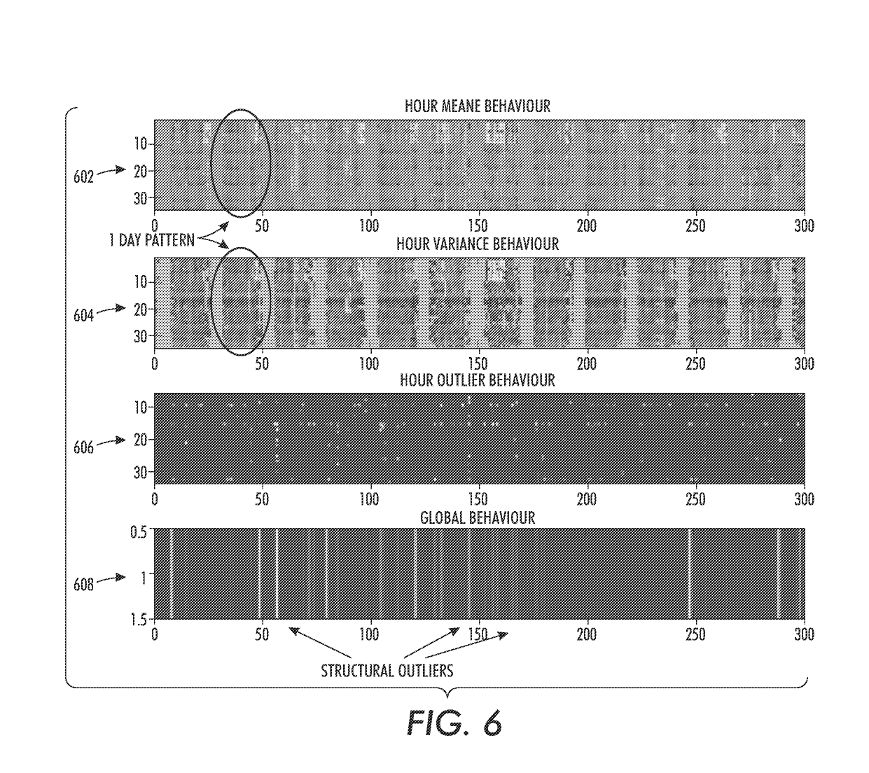

FIG. 5 illustrates graphs 502 and 504 respectively depicting example data indicative of bus stop values for one route and route coverage by a selected pair of stops, in accordance with the disclosed embodiments. Graph 502 depicts stop volumes for the longest route in a Nancy city (e.g., 58 stops), where a stop volume is the number of validation timestamps at the stop, over a fixed period of time (e.g., September 2010). One can see the difference between high and low volumes and their unequal distribution over the route. Graph 504 depicts an example of another route with 14 stops and the result of stop selection accomplished by Algorithm 1 for N=25. In the figure, selected stop pairs are shown by segments; and non-selected pairs are indicated by dashed lines.

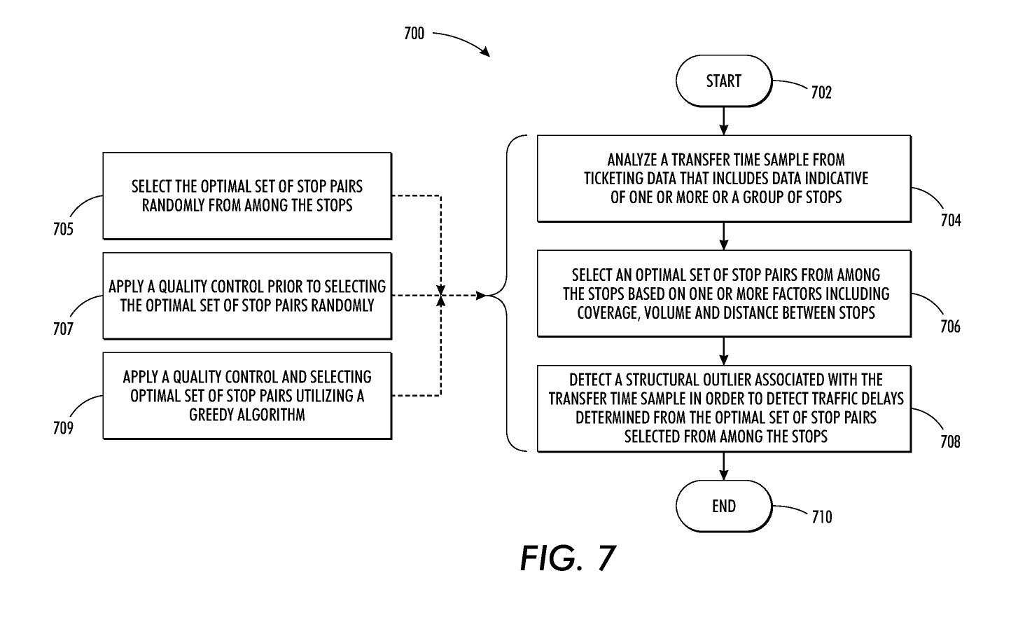

FIG. 6 illustrates a graphic interface for structured outlier detection, in accordance with the disclosed embodiments. Four graphs 602, 604, 606, and 608 are shown in FIG. 6. Graph 602 indicates hourly means, and graph 604 provides data representative of hourly variances. Hourly outlier ratios are shown indicated by the data presented in graph 606. Graph 608 illustrates data indicative of hourly Mahalanobis distances.

Thus, FIG. 6 depicts the graphic interface for structured outlier detection, for the longest bus line in Nancy city with the selected 35 stop pairs. FIG. 6 presents the component of traffic visual analytics covering a two week period, on the hourly basis. In all plots/graphs shown in FIG. 6, one column aggregates 1 hour information, ranging from 1 to 300. The top plots/graphs 602 and 604 report the deviations of hourly mean and variances from the accumulated average values, for all 35 selected stop pairs (rows). Their block-wise structure is due to low traffic over night hours. The third plot/graph 606 depicts the hourly outlier detection (e.g., one line for one selected pair). Colored points different from dark blue, for example, can refer to important deviations for the corresponding stop pairs and hours. Finally, the last plot/graph 608 reports the structural outlier detection by the Mahalanobis distance for all observations on the hourly basis. Dark blue colors can indicate, for example, hours with low distance and therefore normal traffic. Instead, red and yellow colors can indicate high distance values and therefore the important traffic delays. It can be appreciated that the drawings referred to herein, although rendered in black and white for purposes of this document, are preferably implemented with appropriate color variations for clarity in actual embodiments.

The method for structural outlier detection from validation timestamps can be partially validated on Nancy routes for which the schedule delay information collecting by AVL system (e.g., covering about 13% of routes and 4% of bus rides) is disposed. The validation can be implemented manually and can be accomplished by testing three versions of the structural outlier detection. One approach skips the quality control and selects stop pairs randomly. Another approach applies the quality control but still makes the random stop selection. Finally, a third approach applies both the quality control and stop selection by a “greedy algorithm” as discussed herein.

For three selected routes with available AVL data, the 20 most probable delay cases can be selected detected according to one or more of the approaches described herein. For candidate delays, data have been aggregated on the same hour basis, as proportion of at least 10 minutes delays in the whole AVL records.

The Pearson linear correlation coefficient can be measured between the Mahalanobis distance values of delay candidates and the corresponding delay ratios from AVL. Examples of obtained coefficients are 0.55, 0.61 and 0.86, respectively. These numbers indicate than the quality control and in particular the accurate stop selection can increase considerably the prediction precision.

FIG. 6 illustrates a high-level flow chart of operations depicting logical operational steps of a method 600 for detecting traffic delays, in accordance with an embodiment. It can be appreciated embodiments alternative to the method 600 may also be implemented while still falling within the scope of the disclosed embodiments herein. As indicated at block 602, the process can begin. Thereafter, as shown at block 604, a step or logical operation can be implemented for analyzing a transfer time sample from ticketing data that includes data indicative of one or more or a group of stops. Next, as depicted at block 606, a step or logical operation can be provided for selecting an optimal set of stop pairs from among the stops (e.g., group of stops) based on one or more factors including, for example (but not limited to): coverage, volume, and/or distance between stops, etc. Thereafter, as illustrated at block 608, a step or logical operations can be implemented for detecting a structural outlier associated with the transfer time sample in order to detect traffic delays determined from the optimal set of stop pairs selected from among the stops. The process can then terminate, as shown at block 610.

Note that one or more optional or alternative steps/logical operations can also be implemented in accordance with the method 600. For example, as indicated at block 605 a step or logical operation can be implemented for selecting the optimal set of stop pairs randomly from among the stops. Additionally, as shown at block 607 a step or logical operation can be implemented for applying a quality control prior to selecting the optimal set of stop pairs randomly. Also, as illustrated at block 609, a step or logical operation can be provided for applying a quality control and selecting an optimal set of stop pairs utilizing a greedy algorithm as discussed previously here.

Based on the foregoing, it can be appreciated that a method, system and processor-readable medium can be implemented for mining ticket validation data collected by AFC systems for traffic delay detection. In installation where AVL data are not available or partial, ticket validation data represents an important source of information and can serve as a solid alternative or complement to the AVL data. The disclosed approach is generally composed of three main elements: the quality control, the stop set selection and the structural outlier detection.

Based on the foregoing, it can be appreciated that a number of embodiments, preferred and alternative, are disclosed herein. For example, in one embodiment, a method can be implemented for detecting traffic delays. Such a method can include the steps of, for example, analyzing a transfer time sample from ticketing data that includes data indicative of a plurality of stops; selecting an optimal set of stop pairs from among the plurality of stops based on a plurality of factors including a coverage, a volume and a distance between at least two stops among the plurality of stops; and detecting a structural outlier associated with the transfer time sample in order to detect traffic delays determined from the optimal set of stop pairs selected from among the plurality of stops. In another embodiment, the structural outlier can include an outlier in a spatio-temporal series collected from the transfer time sample. In still another embodiment, such ticketing data can include (but is not necessarily limited to) ticket validation timestamps. In other embodiments, a step can be implemented for selecting the optimal set of stop pairs randomly from among the plurality of stops. In still other embodiments, a step can be implemented for applying a quality control prior to selecting the optimal set of stop pairs randomly. In other embodiments, a step can be provided for applying a quality control and selecting the optimal set of stop pairs utilizing a greedy algorithm.

In another embodiment, a system can be provided for detecting traffic delays and may include, for example, a processor, a data bus coupled to the processor, and a computer-usable medium embodying computer program code. The computer-usable medium can be coupled to the data bus, and computer program code can include instructions executable by the processor and configured, for example, for analyzing a transfer time sample from ticketing data that includes data indicative of a plurality of stops; selecting an optimal set of stop pairs from among the plurality of stops based on a plurality of factors including a coverage, a volume and a distance between at least two stops among the plurality of stops; and detecting a structural outlier associated with the transfer time sample in order to detect traffic delays determined from the optimal set of stop pairs selected from among the plurality of stops.

In some system embodiments, the structural outlier can include an outlier in a spatio-temporal series collected from the transfer time sample. In other system embodiments, the ticketing data can include (but is not necessarily limited to) ticket validation timestamps. In another system embodiment, such instructions can be further configured for selecting the optimal set of stop pairs randomly from among the plurality of stops. In yet other system embodiments, such instructions can be further configured for applying a quality control prior to selecting the optimal set of stop pairs randomly. In still other system embodiments, such instructions can be further configured for applying a quality control and selecting the optimal set of stop pairs utilizing a greedy algorithm.

In another embodiment, a processor-readable medium storing code representing instructions to cause a process for detecting traffic delays can be provided. Such code may include code, for example to analyze a transfer time sample from ticketing data that includes data indicative of a plurality of stops; select an optimal set of stop pairs from among the plurality of stops based on a plurality of factors including a coverage, a volume and a distance between at least two stops among the plurality of stops; and detect a structural outlier associated with the transfer time sample in order to detect traffic delays determined from the optimal set of stop pairs selected from among the plurality of stops.

In another embodiment of a processor-readable medium, the structural outlier can include an outlier in a spatio-temporal series collected from the transfer time sample. In yet another embodiment of a processor-readable medium the ticketing data can include (but is not necessarily limited to) validation timestamps. In another embodiment of a processor-readable medium the code can further include code to select the optimal set of stop pairs randomly from among the plurality of stops. In still another embodiment of a processor-readable medium, the code can further include code to apply a quality control prior to selecting the optimal set of stop pairs randomly. In another embodiment of a processor-readable medium, the code can include code to select the optimal set of stop pairs utilizing a greedy algorithm.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for detecting traffic delays, said method comprising:
analyzing a transfer time sample from ticketing data that includes data indicative of a plurality of stops;
selecting an optimal set of stop pairs from among said plurality of stops based on a plurality of factors including a coverage, a volume and a distance between at least two stops among said plurality of stops; and
detecting a structural outlier associated with said transfer time sample in order to detect traffic delays determined from said optimal set of stop pairs selected from among said plurality of stops.

2. The method of claim 1 wherein said structural outlier comprises an outlier in a spatio-temporal series collected from said transfer time sample.

3. The method of claim 1 wherein said ticketing data comprises ticket validation timestamps.

4. The method of claim 1 further comprising selecting said optimal set of stop pairs randomly from among said plurality of stops.

5. The method of claim 4 further comprising applying a quality control prior to selecting said optimal set of stop pairs randomly.

6. The method of claim 1 further comprising applying a quality control and selecting said optimal set of stop pairs utilizing a greedy algorithm.

7. The method of claim 6 further comprising selecting said optimal set of stop pairs randomly from among said plurality of stops.

8. A system for detecting traffic delays, said system comprising:
a processor;
a data bus coupled to said processor; and
a computer-usable medium embodying computer program code, said computer-usable medium being coupled to said data bus, said computer program code comprising instructions executable by said processor and configured for:
analyzing a transfer time sample from ticketing data that includes data indicative of a plurality of stops;
selecting an optimal set of stop pairs from among said plurality of stops based on a plurality of factors including a coverage, a volume and a distance between at least two stops among said plurality of stops; and
detecting a structural outlier associated with said transfer time sample in order to detect traffic delays determined from said optimal set of stop pairs selected from among said plurality of stops.

9. The system of claim 8 wherein said structural outlier comprises an outlier in a spatio-temporal series collected from said transfer time sample.

10. The system of claim 8 wherein said ticketing data comprises ticket validation timestamps.

11. The system of claim 8 wherein said instructions are further configured for selecting said optimal set of stop pairs randomly from among said plurality of stops.

12. The system of claim 8 wherein said instructions are further configured for applying a quality control prior to selecting said optimal set of stop pairs randomly.

13. The system of claim 8 wherein said instructions are further configured for applying a quality control and selecting said optimal set of stop pairs utilizing a greedy algorithm.

14. The method of claim 6 wherein said instructions are further configured for selecting said optimal set of stop pairs randomly from among said plurality of stops.

15. A processor-readable medium storing code representing instructions to cause a process for detecting traffic delays, said code comprising code to:
analyze a transfer time sample from ticketing data that includes data indicative of a plurality of stops;
select an optimal set of stop pairs from among said plurality of stops based on a plurality of factors including a coverage, a volume and a distance between at least two stops among said plurality of stops; and
detect a structural outlier associated with said transfer time sample in order to detect traffic delays determined from said optimal set of stop pairs selected from among said plurality of stops.

16. The processor-readable medium of claim 15 wherein said structural outlier comprises an outlier in a spatio-temporal series collected from said transfer time sample.

17. The processor-readable medium of claim 15 said ticketing data comprises ticket validation timestamps.

18. The processor-readable medium of claim 15 wherein said code further comprises code to select said optimal set of stop pairs randomly from among said plurality of stops.

19. The processor-readable medium of claim 18 wherein said code further comprises code to apply a quality control prior to selecting said optimal set of stop pairs randomly.

20. The processor-readable medium of claim 15 wherein said code further comprises code to select said optimal set of stop pairs utilizing a greedy algorithm.
